(19) United States
(12) Patent Application Publication
(10) Pub. No.: US 2004/0003194 A1
(43) Pub. Date: Jan. 1, 2004

(54) Method and apparatus for adjusting DRAM signal timings

(76) Inventors: Amit Bodas, Folsom, CA (US); Zohar B. Bogin, Folsom, CA (US); David E. Freker, Sacramento, CA (US); Girish P. Ramanathan, Rancho Cordova, CA (US); Sridhar Ramaswamy, Folsom, CA (US)

Correspondence Address: Michael J. Mallie, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/185,886

(22) Filed: Jun. 26, 2002

(51) Int. Cl. G06F 12/00

(52) U.S. Cl. 711/167; 711/105

(57) ABSTRACT

A method and apparatus for adjusting memory signal timings by shifting the timing of a clock signal generated by a memory controller relative to the time at which other signals begin to be transmitted by the memory controller.

### FIELD OF THE INVENTION

A method and an apparatus for adjusting memory signal timings by shifting the timing of a clock signal relative to setup timings for other signals is disclosed.

### ART BACKGROUND

Digital electronic systems, such as computers, have long required random access memory systems for relatively quick access to data. Over time, and with the increasing complexity of electronic systems, such memory systems have developed into implementations using a memory controller providing a memory interface generating a memory bus to which one or more memory devices are coupled.

As these digital electronic systems have continued to become ever faster, the speeds at which such memory interfaces operate have continued to increase. As a result, the length of the intervals between times when the latching of signals occurs have continued to decrease, and this has forced a decrease in the amount of time allocated for signals to stabilize, i.e., the “setup time” prior to the latching of signals.

Signal setup times are required to allow a signal sent by one component to another to propagate the length of a conductor and arrive at the other component, as well as time to allow the signal where it is received by the other component to fully “settle” and allow the effects on the quality of the signal caused by imperfections in the layout of the conductor, variations in the characteristics of the transmitting and receiving component, as well as a host of other possible factors, to pass.

However, the decreasing amounts of time available to allocate for setup time has removed much of the “padding” of extra time that used to exist in which provision could be made for setup time while still absorbing a degree of imprecision in how time was allocated. The result has been memory interface timings that are becoming progressively less forgiving of even a small degree of imprecision in allocating time, including setup time.

One response to the increasing need for precision in allocating timing is the use of a memory interface generating a synchronous memory bus, rather than an asynchronous memory bus. In a synchronous memory bus, the timing of the transmission and latching of signals is synchronized to a clock signal, usually transmitted by the memory controller generating the memory bus. However, as memory interfaces still continue to become ever faster, still greater precision in the allocation of time is being required which poses ever greater design challenges, even with a synchronous clock present.

### BRIEF DESCRIPTION OF THE DRAWINGS

The objects, features, and advantages of the invention as hereinafter claimed will be apparent to one skilled in the art in view of the following detailed description in which:

FIG. 1 is a timing diagram of an embodiment of signals of a memory interface.

FIG. 2a and 2b are block diagrams of two embodiments of a delay logic.

FIG. 3 is a block of an embodiment of a computer system.

### DETAILED DESCRIPTION

Although numerous details are set forth for purposes of explanation and to provide a thorough understanding in the following description, it will be apparent to those skilled in the art that these specific details are not required in order to practice the invention as hereinafter claimed.

A technique for adjusting memory signal timings by shifting the timing of a clock signal relative to setup timings for other signals is disclosed. Specifically, an embodiment concerns using a programmable delay to shift a clock signal relative to other signals to enhance the setup times of other signals for latching. However, although embodiments are discussed in reference to memory devices, the invention as hereinafter claimed is also applicable to a variety of other devices such as CPUs (i.e., central processing units) and/or I/O devices coupled to processor and/or peripheral interfaces, and/or any of a variety of buses.

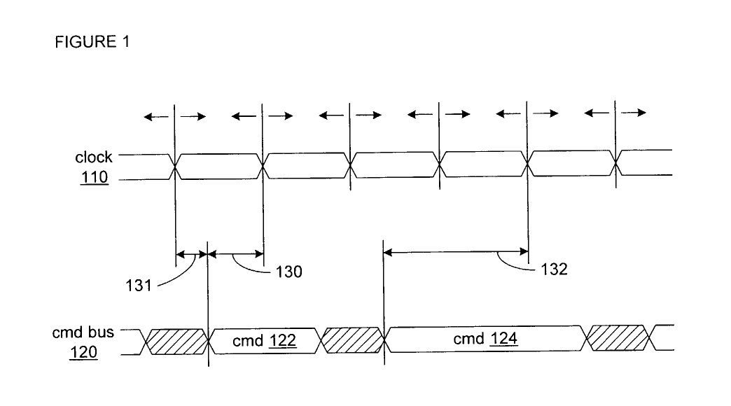

FIG. 1 depicts a timing diagram of an embodiment in the form of a memory interface. The memory interface includes clock 110 of a given frequency (and therefore, a given clock period) to provide transitions at regular intervals and command bus 120. As depicted, clock 110 is transmitted as a pair of signals providing a differential clock, but as those skilled in the art will recognize, clock 110 may be transmitted as a single signal, or in any of a variety of other forms. Command bus 120 is made up of one or more signals transmitting addresses and/or commands.

Specifically, a memory controller (not shown) generates clock 110 and command bus 120. Clock 110 and command bus 120 are transmitted to one or more memory devices (also not shown), each of which could be an integrated circuit or a small circuitboard to which one more integrated circuits are attached such as a SIMM, SIPP or DIMM module. To transmit a command to a memory device, a memory controller first generates command 122 on command bus 120 at the beginning of time interval 130. At the end of time interval 130, clock 110 makes a transition and this signals the memory device to latch the command on command bus 120.

Within time interval 130 is intended to be the setup time allocated to allow the signals of command bus 120 received by a memory device to fully stabilize so that the signals of command bus 120 can be reliably latched by a memory device so as to latch command 122 before command bus 120 is used by the memory controller to transmit another command (or other information, such as an address). If time interval 130 is long enough, then minimum setup time requirements for the signals of command bus 120 are met, and the signals of command bus 120 can be reliably latched by the memory device. To ensure that time interval 130 is long enough, the memory controller shifts the position of the transitions of clock 110 (in essence, shifting the positions of the starting and ending points of each of the cycles of clock 110) relative to the position of transitions on command bus 120 associated with the beginning of the transmission of command 122 on command bus 120. This has the effect of shortening or lengthening time interval 130 as needed to both ensure that interval 130 is long enough to provide sufficient setup time for the signals of command bus 120, but short enough to not shift the transitions of clock 110 so far as to cause time interval 131 to be too short. Causing time interval 131 to be too short may cause the memory interface to violate timing requirements of a widely accepted memory interface standard, if the memory interface was intended to conform to a specific memory interface standard. Also, causing time interval 131 to be too short may cause some implementations of memory devices to mistake a wrong transition in clock 110 as signaling the time at which the signals of command bus 120 are meant to be latched in order to latch command 122, and this could cause a memory device to latch the signals of command bus 120 even before command 122 begins to be transmitted by the memory controller.

However, instead of latching the signals of command bus 120 with the very first transition in clock 110 subsequent to the beginning of the transmission of a command, it may necessary to arrange for the memory device to latch a command on command bus 120 at the occurrence of the second of two subsequent transitions of clock 110, as is shown for the transmission of command 124. This may be required because the conductors between a memory controller and a memory device are relatively long, the conductors are designed in such a way that a considerable level of signal noise is introduced into the signals of command bus 120, or a relatively slow memory device is being used. At the beginning of time interval 132, the memory controller begins transmitting command 124 on command bus 120, and command 124 is latched by the memory device at the end of time interval 132. Although time interval 132 is considerably longer than time interval 130, allowing considerably more setup time for the signals of command bus 120, the occurrences of the transitions in clock 110 may still be shifted by the memory controller to ensure that the transitions in clock 110 meet the timing requirements of a given memory interface specification at the point where signals of clock 110 and command bus 120 are received by a memory device. It may also be the case that a considerable mismatch exists between the lengths of the trace or traces used to route clock 110 and the traces used to route the signals of command bus 120, and shifting the transitions of clock 110 relative to transitions of the signals of command bus 120 is needed to compensate. Furthermore, it may prove advantageous to be able to shift the relative positions of the transitions of clock 110 and the signals of command bus 120 to compensate for imperfections in the design or fabrication process used in manufacturing the memory controller.

As already mentioned, the memory interface of which clock 110 and command bus 120 are a part could be implemented to conform to any of a number of widely known and recognized specifications. Specifically, the memory interface of which clock 110 and command bus 120 are a part may be designed to conform to the specifications of DDR (double data rate) SDRAM (synchronous dynamic random access memory) interfaces currently in wide use in many computer systems, wherein the memory interface provides a memory bus on which there is bus activity, including the latching of signals (command, address and/or data signals), may be synchronized to any half cycle of a clock (i.e., any transition of a clock, as opposed to single data rate designs where only every other transition is used). However, as those skilled in the art will recognize, conforming to a particular specification is not necessary to the practice of the invention as hereinafter claimed.

As will be apparent to those skilled in the art, myriad other reasons may exist for time intervals 130 and/or 132 not being either long enough to provide sufficient setup times, or perhaps being too long so as to violate a specification or cause mistiming of the latching of signals. However, regardless of the reason, an analysis of signals at the point where they are received by a memory device may be used to determine whether or not time intervals 130 and/or 132 require lengthening or shortening, and to what degree.

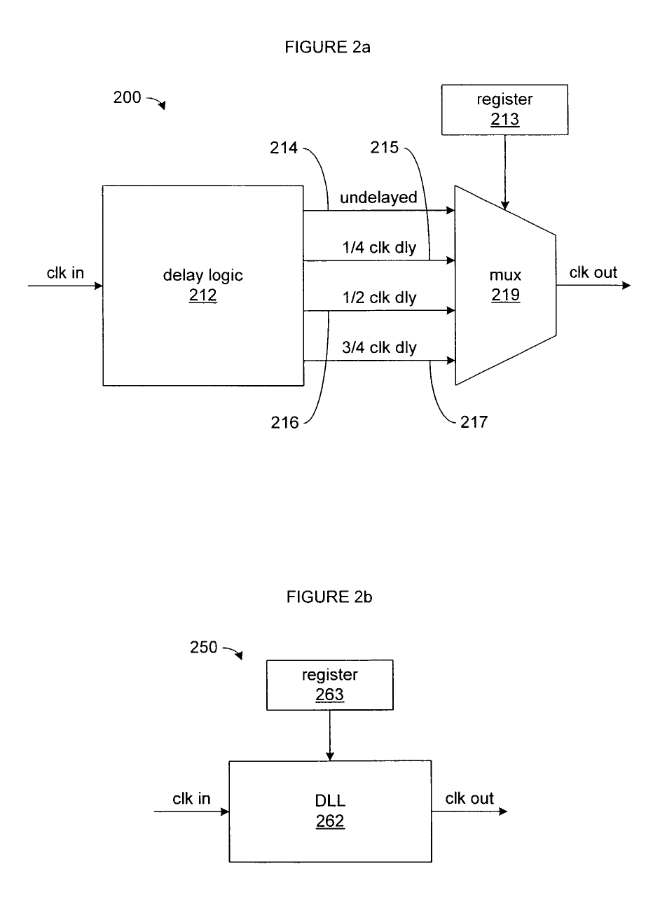

FIGS. 2a and 2b depict two embodiments of delay logic for adjusting a clock signal. Specifically, logic 200 and logic 250 are implementations of electronic circuitry that could be used to shift the position of the transitions in a clock signal (in essence, shifting the start and end points of each cycle of a clock signal) relative to transitions in other signals in order to adjust the amount of time allocated for signal setup time. Although depicted as separate embodiments, logic 200 and logic 250 could also be used together to provide more flexibility in controlling the degree of shifting of a clock signal.

Logic 200 of FIG. 2a includes delay logic 212 which receives a clock input and from that clock input, logic 212 outputs clock signal 214 that passes through the clock input without change, clock signal 215 that provides a version of the clock input that is delayed by ¼ of a clock cycle, clock signal 216 that provides a version of the clock input that is delayed by ½ of a clock cycle, and clock signal 217 that provides a version of the clock input that is delayed by ¾ of a clock cycle. All four of clock signals 214-217 are fed from delay logic 212 to multiplexer 219, and under the control of register 213, multiplexer 219 passes through one of clock signals 214-217 as the clock output of logic 200. Delay logic 212 may be implemented using digital circuitry to create shifted versions of the clock input using binary mathematical algorithms. Alternatively, delay logic 212 may be implemented using flip-flops and/or latches requiring a known quantity of time for a signal to pass through to create shifted versions of the clock input. As those skilled in the art will recognize the specific degrees of delay depicted in this embodiment are but examples. The degree of delay of each version of the clock input provided by delay logic 212 and the quantity of such signals provided may be changed without departing from the spirit and scope of the invention as hereinafter claimed.

Logic 250 of FIG. 2b includes DLL 262 which receives a clock input and provides a clock output that is shifted to a degree that is controlled through register 263. DLL 262 may be implemented using any of a number of technologies and/or designs, having any number of available delay settings and degrees of delay as those skilled in the art will readily recognize.

As previously mentioned, it may be that both logic 200 and logic 250 are used together with one of logic 200 and logic 250 providing its clock output as a clock input to the other. In such a configuration, it may be that logic 200 is used to provide a form of “coarse” adjustment of shifting of a clock signal, while logic 250 is used to provide a somewhat more “fine” adjustment of shifting.

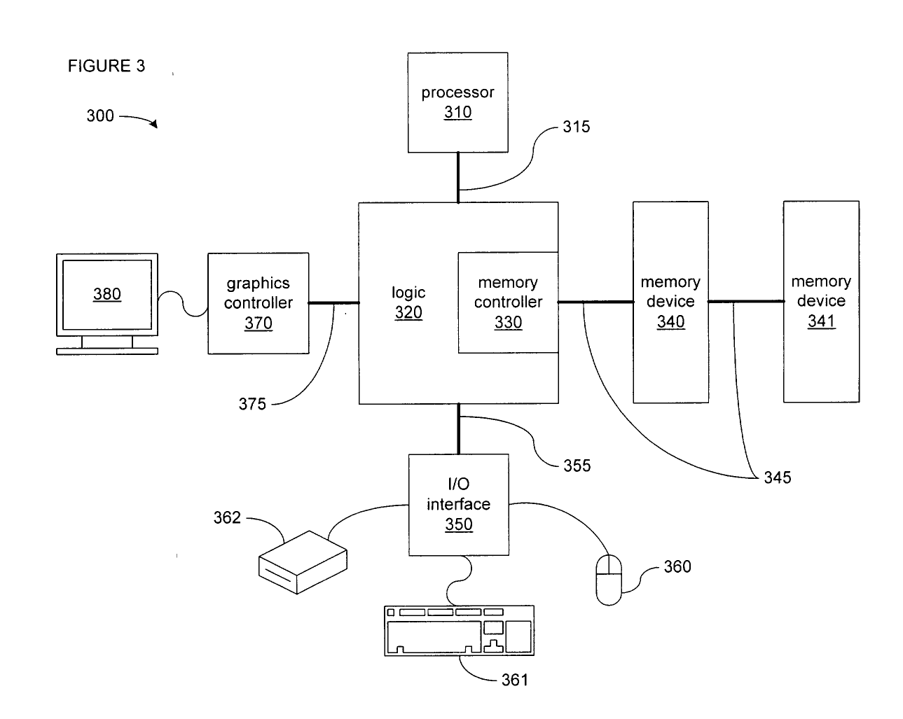

FIG. 3 depicts an embodiment of a computer system. Computer system 300 includes processor 310 coupled through bus 315 to logic 320 that includes memory controller 330 which has a memory interface generating memory bus 345 that couples memory controller 330 to memory devices 340 and 341. Depending on the design or intended purpose of computer system 300, logic 320 may be further coupled through bus 355 to I/O interface 350, which may in turn, be further coupled to I/O devices such as mouse 360, keyboard 361 and/or data storage device 362. Logic 320 may also be further coupled through bus 375 to graphics controller 370 which may be further coupled to display 380.

Memory controller 330 may be incorporated within logic 320, as depicted, or may alternatively be incorporated within one or more physically separate integrated circuits. Memory controller is a block of logic linking a memory interface that generates memory bus 345 to other components of computer system 300, and may be implemented using a sequencer, microcontroller or other device creating a state machine or similar processing device. Memory bus 345 includes a clock and one or more other signals generated by memory controller 330 that could convey addresses, commands and/or data. Memory devices 340 and 341 use the clock to time the latching of those other signals generated by memory controller 330 to latch addresses, commands and/or data. To ensure that transitions in the clock occur at times relative to transitions in one or more of those other signals so as to permit sufficient setup time for those other signals prior to latching, memory controller 330 includes logic to shift the transitions of the memory clock relative to the transitions of those other signals. The logic to shift the clock may be based on the use of digital circuitry employing one or more binary algorithms and/or based on the use of one or more DLL circuits.

In one variation of this embodiment, the degree of shifting of the clock signal in memory bus 345 may be controlled through registers thereby permitting adjusting of the shifting of the clock by processor 310 running software. With such a variation, the maker of an integrated circuit incorporating logic capable of shifting the clock signal could provide software and/or register settings to manufacturers of devices incorporating those integrated circuits. Such software could be carried by a storage device (not shown) in the form of a solid state device attached to a circuitboard comprising computer system 300. Furthermore, those register settings could be based on timing characteristics of the memory controller, possibly compensating for design and/or manufacturing imperfections, or possibly providing fine tuning of the timing of a memory bus to improve its operation.

In another variation of this embodiment, the degree of shifting of the clock signal in memory bus 345 may be controlled through such mechanisms as the tying of pins of an integrated circuit to various voltage levels via resistors on a circuitboard to which the integrated circuit is mounted or other components. With such a variation, a maker of a circuitboard that uses a memory controller having the logic to shift the clock could adjust the shift of the clock to fit circumstances introduced by characteristics unique to the design of a given circuitboard.

The invention has been described in conjunction with the preferred embodiment. It is evident that numerous alternatives, modifications, variations and uses will be apparent to those skilled in the art in light of the foregoing description. It will be understood by those skilled in the art that the invention as hereinafter claimed may be practiced in support of setting timings of various components of digital electronic systems including, but not limited to computer systems. Furthermore, although much of the foregoing discussion has centered on the interaction of memory controllers and/or logic performing a similar function with memory devices, it will be understood by those skilled in the art that the invention as hereinafter claimed may be practiced with regard to interactions between any of a wide variety of types of electronic components that may or may not incorporate memory or memory controller functions.

What is claimed is:

1. A method comprising:
setting a degree to which a clock signal is delayed such that the transitions of the clock signal as received by a memory device are delayed;
beginning the transmission of at least one command signal to the memory device;
transmitting the clock signal with at least one transition in the clock signal being timed to occur after the beginning of the transmission of the at least one command signal to the memory device, wherein the position of the at least one transition in the clock signal relative to the beginning of the transmission of the at least one command signal to the memory device is adjusted based on the setting of the degree to which the clock signal is delayed; and
latching the at least one command signal to a memory device at a time controlled by the occurrence of the at least one transition in the clock signal.

2. The method of claim 1, wherein the setting of the degree to which the clock signal is delayed further comprises using digital circuitry employing at least one binary mathematical algorithm to provide at least one selectable degree of delay in the clock signal, and selecting the at least one selectable degree of delay.

3. The method of claim 1, wherein the setting of the degree to which the clock signal is delayed further comprises using a DLL to cause delay the clock signal.

4. The method of claim 1, wherein the setting of the degree to which the clock signal is delayed further comprises setting the degree of delay to cause the interval of time between the beginning of the transmission of at least one command signal to the memory device and the at least one transition in the clock to be long enough provide enough setup time for the at least one command signal transmitted to the memory device to settle.

5. The method of claim 1, wherein the beginning the transmission of the at least one command signal to the memory device further comprises beginning to transmit a command to the memory device.

6. An apparatus comprising:
a memory controller generating a clock signal and at least one command signal, wherein the memory controller further comprises logic to selectively delay the clock signal by a controllable degree;
a memory device; and
a plurality of conductors coupling the memory controller to the memory device, and through which the clock signal and the at least one command signal are transmitted.

7. The apparatus of claim 6, wherein the logic to selectively delay the clock signal is comprised of digital circuitry implementing at least one binary mathematical algorithm to provide at least one selectable degree of delay in the clock signal.

8. The apparatus of claim 6, wherein the logic to selectively delay the clock signal is comprised of a DLL.

9. The apparatus of claim 6, wherein the logic to selectively delay the clock signal is comprised of both digital circuitry implementing at least one binary mathematical algorithm and a DLL to provide at least one selectable degree of delay in the clock signal.

10. The apparatus of claim 6, wherein the clock signal and the at least one command line comprise a synchronous memory bus generated by the memory controller, wherein at least some activity on the memory bus is synchronized to the clock signal.

11. The apparatus of claim 10, wherein the synchronous memory bus generated by the memory controller is a double date rate memory bus wherein the at least some activity may be synchronized to any half cycle of the clock signal.

12. A computer system comprising:
a processor;
a memory controller coupled to the processor and generating a clock signal and at least one command signal, wherein the memory controller further comprises logic to selectively delay the clock signal by a controllable degree;
a memory device; and
a plurality of conductors coupling the memory controller to the memory device, and through which the clock signal and the at least one command signal are transmitted.

13. The computer system of claim 12, wherein the logic to selectively delay the clock signal is comprised of digital circuitry implementing at least one binary mathematical algorithm to provide at least one selectable degree of delay in the clock signal.

14. The computer system of claim 12, wherein the logic to selectively delay the clock signal is comprised of a DLL.

15. The computer system of claim 12, wherein the logic to selectively delay the clock signal is comprised of both digital circuitry implementing at least one binary mathematical algorithm and a DLL to provide at least one selectable degree of delay in the clock signal.

16. The computer system of claim 12, wherein the clock signal and the at least one command line comprise a synchronous memory bus generated by the memory controller, wherein at least some activity on the memory bus is synchronized to the clock signal.

17. The computer system of claim 16, wherein the synchronous memory bus generated by the memory controller is a double date rate memory bus wherein the at least some activity may be synchronized to any half cycle of the clock signal.

18. The computer system of claim 16, wherein the memory controller provides registers accessible to the processor to control the degree of delay of the clock signal.

19. The computer system of claim 12, wherein the degree of delay of the clocks signal is selectable by tying one or pins of an integrated circuit of the computer system to one of a plurality of voltage levels through resistors attached to the circuitboard to which the integrated circuit is also attached.

20. The apparatus of claim 12, wherein the memory device is comprised of a plurality of integrated circuits attached to a small circuitboard plugged into a socket that is attached to the circuitboard to which an integrated circuit comprising the memory controller is also attached.

21. A computer readable medium comprising instructions, which when executed by a processor, causes the processor to:
access a memory controller to which the processor is coupled;
set a degree to which a clock signal generated by the memory controller is delayed such that the transitions of the clock signal as received by a memory device are delayed;
cause the memory controller to begin transmitting at least one command signal to a memory device to which the memory controller is coupled; and
cause the memory controller to transmit the clock signal with at least one transition in the clock signal being timed to occur after the beginning of the transmission of the at least one command signal to the memory device, wherein the position of the at least one transition in the clock signal relative to the beginning of the transmission of the at least one command signal to the memory device is adjusted based on the setting of the degree to which the clock signal is delayed.

22. The computer readable medium of claim 21, wherein the computer readable medium is comprised of a solid state device attached to a circuitboard to which the processor is also attached.

23. The computer readable medium of claim 21, wherein the processor refers to data accompanying the instructions comprising the computer readable medium to determine the degree to which the clock signal generated by the memory controller should be delayed.
